(19) United States
(12) Patent Application Publication
(10) Pub. No.: US 2021/0233191 A1
(43) Pub. Date: Jul. 29, 2021

(54) METHOD, APPARATUS AND COMPUTER PROGRAM FOR OPERATING A MACHINE LEARNING FRAMEWORK WITH ACTIVE LEARNING TECHNIQUE

(71) Applicant: RIIID INC., Seoul (KR)

(72) Inventors: Dong Min Shin, Seoul (KR); Young Ku Lee, Seoul (KR)

(21) Appl. No.: 16/964,823

(22) PCT Filed: Mar. 26, 2020
(86) PCT No.: PCT/KR2020/004137

§ 371 Date: Jul. 24, 2020

(30) Foreign Application Priority Data
Apr. 3, 2019 (KR) 10-2019-0039091

(51) Int. Cl. G06Q 50/20; G06N 20/00; G06N 5/04

(52) U.S. Cl. CPC G06Q 50/20; G06N 5/04; G06N 20/00

(57) ABSTRACT

Provided is a method for analyzing a user in a data analysis server, the method including; step A of establishing a question database comprising a plurality of questions, of collecting solving result data of a user for the plurality of questions, and of learning the solving result data, thereby generating a data analysis model for modeling the user; step B of generating an expert model that recommends learning data necessary for machine learning of the data analysis model; step C of extracting at least one question from the question database according to recommendation from the expert model, and of updating the data analysis model using solving result data of a user for the at least one extracted question; and step D of updating the expert model by applying, to update information of the data analysis model, a reward that is set in a direction to improve prediction accuracy of the data analysis model.

### CROSS-REFERENCE TO RELATED APPLICATIONS

This application is a U.S. National Stage application under 35 U.S.C. § 371 of International Application PCT/KR2020/004137, filed Mar. 26, 2020, which claims the benefit of priority to Korean Patent Application 10-2019-0039091, filed Apr. 3, 2019. Benefit of the filing date of each of these prior applications is hereby claimed. Each of these prior applications is hereby incorporated by reference in its entirety.

### BACKGROUND

### Technical Field

The present disclosure relates to a method for providing user-customized content using a data analysis framework. More specifically, the present disclosure relates to a method for generating an analysis model for a question and/or a user using a large amount of user content consumption result data, and operating an expert model for selecting data necessary to efficiently learn the analysis model.

### Background Art

In general, educational content has been provided in a packaged form to date. For example, one workbook printed on paper has at least 700 questions, and online or offline lectures containing study materials that should be learned for at least one month are sold together in units of one or two hours.

However, since all students have different individual weak points and weak question types, the students need individually customized content rather than content in a packaged form. This is because selectively learning only a weak question type in a weak unit is much more efficient than solving all 700 questions in a workbook.

However, it is very difficult for students who are learners to identify their weak points by themselves. Furthermore, in the conventional educational field, since private educational institutes or publishing companies analyze students and questions depending on subjective experience and intuition, it is not easy to provide questions optimized for individual students.

Thus, in the conventional educational environment, the learners have difficulty in providing individually customized content that elicits more efficient learning results, and the students may not feel a sense of accomplishment and rapidly lose interest in package-type educational content.

### SUMMARY

The present disclosure has been made in view of the above-mentioned problems. More particularly, an aspect of the present disclosure provides a method for operating an expert model for selecting data required to efficiently generate a user and/or question model.

In accordance with an aspect of the present disclosure, a method for analyzing a user in a data analysis server includes: step A of establishing a question database comprising a plurality of questions, of collecting solving result data of a user for the plurality of questions, and of learning the solving result data, thereby generating a data analysis model for modeling the user; step B of generating an expert model that recommends learning data necessary for machine learning of the data analysis model; step C of extracting at least one question from the question database according to recommendation from the expert model, and of updating the data analysis model using solving result data of a user for the at least one extracted question; and step D of updating the expert model by applying, to update information of the data analysis model, a reward that is set to improve prediction accuracy of the data analysis.

According to the present disclosure, it is possible to operate a data selecting model for efficiently improving performance of a data analysis model, separately from the data analysis model, in machine learning. Accordingly, since the data selecting model proposes data for learning the data analysis model, there are effects that the computer resources required to learn the data analysis model can be reduced, that reliability of the data analysis model can be efficiently achieved, and the question of data selection can be solved.

### BRIEF DESCRIPTION OF THE DRAWINGS

FIG. 1 is a view illustrating a problem of a data set for machine learning.

FIG. 2 is a flowchart illustrating a method for operating a learning data analysis model and a data coaching model in a data analysis framework according to an embodiment of the present disclosure.

FIG. 3 is a view illustrating a relationship between a level of understanding of a question X and a probability of correct answer for the question P.

FIG. 4 is a view illustrating a method for ending recommending data for learning a data analysis model according to an embodiment of the present disclosure

### DESCRIPTION OF THE EMBODIMENTS

The present disclosure is not limited to the description of the embodiments described below, and it is obvious that various modifications can be made without departing from the technical gist of the present disclosure. In the following description, well-known functions or constructions are not described in detail since they would obscure the disclosure in unnecessary detail.

In the accompanying drawings, the same components are denoted by the same reference numerals. Further, in the accompanying drawings, some of the elements may be exaggerated, omitted or schematically illustrated. This is intended to clearly illustrate the gist of the present disclosure by omitting unnecessary explanations not related to the gist of the present disclosure.

Recently, as the spread of IT devices has expanded, data collection for user analysis has become easier. If the user data can be sufficiently collected, the analysis of the user becomes more precise, and content in the form most suitable for the user can be provided.

Along with this trend, there is a high demand for provision of user-customized educational content, especially in the education industry. However, in order to provide such user-customized educational content, it is necessary to perform precise analysis of all content and individual users.

Conventionally, in order to analyze content and users, a method in which the concepts of corresponding subjects are manually defined by experts and the concepts of respective questions for the corresponding subject are individually determined and tagged by the experts has been used. Then, the learner's ability may be analyzed based on result information obtained by each user solving questions tagged for a specific concept.

However, this method has a problem in that the tag information depends on the subjectivity of a person. There is a problem in that the reliability of the result data cannot be high because tag information generated mathematically without intervention of subjectivity of a person is not assigned to the corresponding question according to a level of inclusion of a concept in the corresponding question.

Accordingly, the present disclosure aims to provide a method for applying a data analysis framework for big data processing and machine learning to exclude human intervention in learning data processing, and for analyzing a user and/or a question using the data analysis framework.

According to this, a result log of a user's content may be collected, a multidimensional space composed of a user and/or a problem may be constructed, values may be assigned to the multidimensional space based on the result data for the user's consumption of content, such as a problem, commentary, and lecture, data on whether the user's answer for each question is correct or incorrect, data on selection of each choice item for each question, and the like, thereby modeling each user and/or question in a way of calculating a vector for each user and each question, and a user modeling vector and a question modeling vector may be calculated.

In this case, the user modeling vector may be interpreted as a vector value expressing characteristics of each individual user for all the questions, and the question modeling vector may be interpreted as a vector value expressing characteristics of each individual question for all users. Furthermore, the method for calculating the user modeling vector and/or the question modeling vector is not limited, and may follow the conventional practice applied to a big data analysis framework used to calculate the user modeling vector and/or the question modeling vector.

Further, it should be noted that the present disclosure cannot be interpreted as being limited to what attributes or features the user modeling vector and the question modeling vectors include. For example, the user modeling vector may represent characteristics of one individual user among all users, and the question modeling vector may represent characteristics of one individual question among all questions.

For example, according to the embodiment of the present disclosure, the user modeling vector may include the degree to which the user understands an arbitrary concept, that is, a level of understanding of the concept. Furthermore, the question modeling vector may include what concepts the question is constituted of, that is, a concept composition diagram. Furthermore, according to an embodiment of the present disclosure, a probability of correct answer of a particular user for a particular question may be estimated using the user modeling vector and the question modeling vector.

Furthermore, according to an embodiment of the present disclosure, a question vector may be extended into a question-choice item vector by adding parameters for the choices of the question in the process of modeling the question, and a probability for a particular user to select a specific choice item for an arbitrary question may be calculated using the user modeling vector and the question-choice item modeling vector.

However, in order to mathematically model a user and a question using a data analysis framework, it is required to solve the problem of selecting learning data.

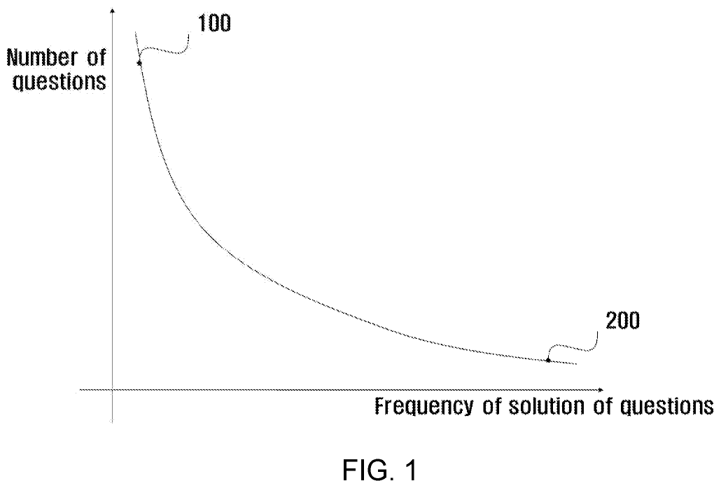

FIG. 1 is a view for explaining a problem of a data set applied to conventional machine learning modeling.

When a large content database is provided to a large number of users, the users do not consume all content at a constant frequency. For example, questions provided in the beginning of introduction of new users or basic questions of each chapter may be solved much more than other problems. Therefore, the number of questions to a frequency of solution may follow a graph shown in FIG. 1. That is, the number of questions that most users solve multiple times in the question database is very small 100, and most questions tend to be solved once or twice by a small number of users 200, and accordingly, thereby following a long tail distribution.

However, when the frequency of solution of the questions follows the distribution as shown in FIG. 1, that is, when the number of frequently solved questions is too small and the number of occasionally solved questions is too large, a data analysis model generated using the corresponding data may have an imbalanced data problem.

For example, if questions regarding gerunds are frequently solved in the English subject, an analysis model learned by applying corresponding solution data may generate a model biased toward the concept of gerunds, not for the whole English subject. That is, a user model generated by learning a data set biased toward question solution data regarding gerunds may dominantly reflect a level of understanding of the concept of gerunds, not the entire concepts constituting the English subject.

In addition, a question model generated through learning based on a data set biased toward the question solution data regarding gerunds may dominantly reflect a level of inclusion of the concept of gerunds, not the entire concepts constituting the English subject. In this case, the performance of the user/question model is difficult to be evaluated high. For example, a probability for getting correct answer of a corresponding user for a question regarding infinitive verbs, calculated using the user model, and an actual solving result of the user for the same question may be largely different.

Therefore, in order to improve performance of the machine learning model, it is essentially required to select data having redundant information and to distinguish data having necessary information.

To this end, a passive learning method has been used in which each data constituting the entire data set is used as a machine learning input for generating an analysis model. This means that in the machine learning framework, the entire data set is divided into parts of a size suitable to be learned all at once and all the divided parts of the data set is used as inputs, and therefore, all the data can be passively received and learned in the analysis model without any selecting of the data.

However, this method has a problem in that a massive amount of data is used to generate the analysis model and thus an excessive amount of resources is consumed to generate the data analysis model. In the above example regarding the data set biased toward gerunds, in order to construct a model that reflects the entire concepts constituting the English subject, a very large sized data set including even data for other concepts may be required. That is, in order to guarantee a certain level of performance of the analysis model, it is necessary to collect and process a very large sized data set, and thus, a learning process may take a long time and a large cost may arise to operate the data analysis framework.

Accordingly, the present disclosure aims to provide a method for operating not just a data analysis model but also an expert model that coaches data necessary to learn the data analysis model.

According to an embodiment of the present disclosure, the expert model may recommend data necessary for the data analysis model to be updated in a preset direction according to a state of the data analysis model at a corresponding point in time. Furthermore, the data analysis model according to an embodiment of the present disclosure may learn solving result data for a question having a modeling vector that is close to data recommended by the expert model. In this case, the data analysis model may be learned based on data most suitable for a state of a specific point in time in order to improve performance and thus may quickly reach a required level of performance by processing the minimum amount of data.

For example, in the above example regarding a data set biased toward gerunds, an expert model according to an embodiment of the present disclosure may extract vectors having values for concepts other than gerunds and may notify the data analysis model of the extracted vectors. Furthermore, the data analysis model may select questions having modeling vectors close to the vectors, may provide the questions to a user, and may apply solving result data for the questions in a process of generating a user vector so as to reflect a level of understanding of concepts constituting the English subject, thereby solving a problem of data bias.

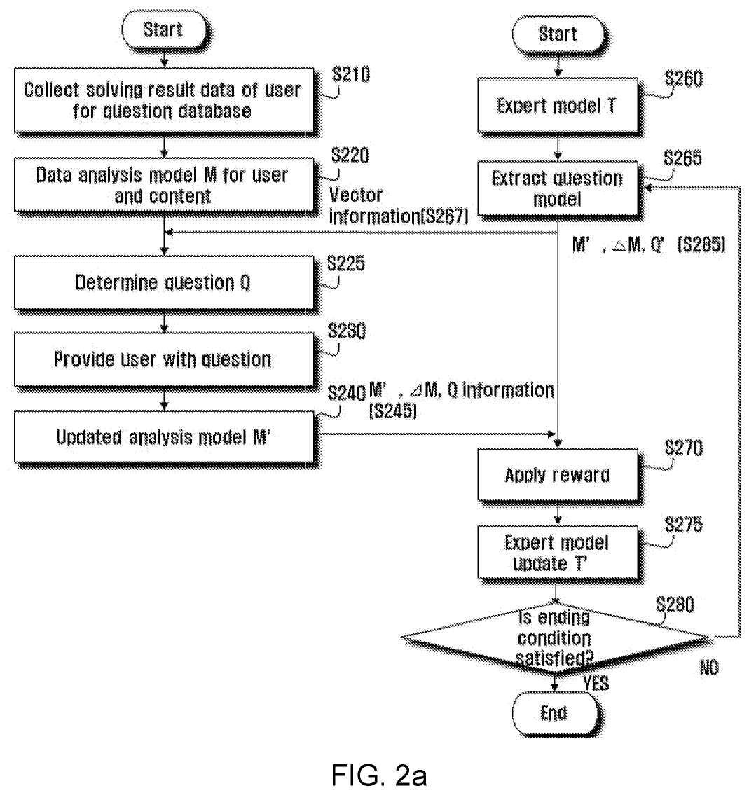

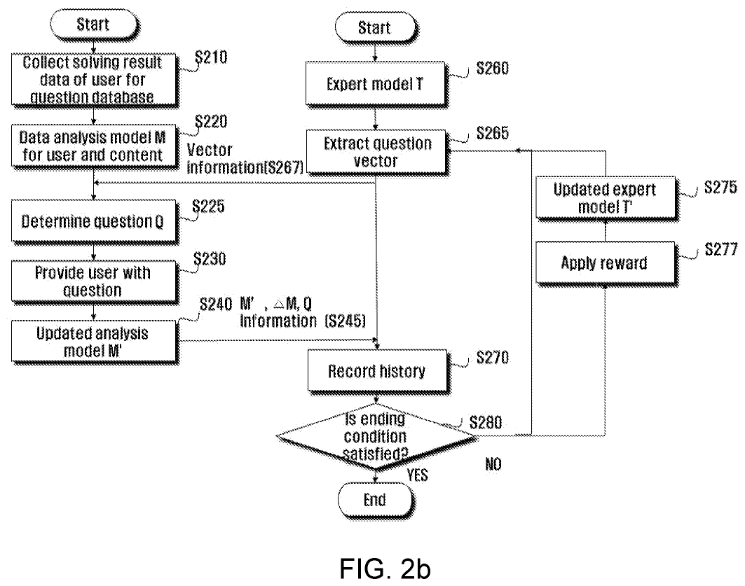

FIG. 2 is a flowchart illustrating a method for operating a learning data analysis model and a data coaching model in a data analysis framework according to an embodiment of the present disclosure. In FIG. 2A, steps 210, 220, 225, 230, and 240 are to explain a process of generating a user and/or question analysis model using data on a content consumption result in a data analysis framework according to an embodiment of the present disclosure, and steps 260, 265, 270, 275, 280, and 285 are to explain a process of generating an expert model that recommends data necessary for efficiently generating the analysis model in the data analysis framework according to an embodiment of the present disclosure.

According to an embodiment of the present disclosure, as shown in FIG. 2A, the user and/or question model and the expert model may be regarded as software configurations that are learned based on different data and perform different functions, but the two models may be organically connected to each other to contribute performance improvement of the entire data analysis framework.

According to an embodiment of the present disclosure, entire content, and content consumption result data of all users may be collected in step 210 of FIG. 2A, and an analysis model M for all the users and/or content may be generated using the content consumption result data in step 220.

For example, a data analysis server may construct a database for learning content such as texts, image, audio, and/or video-type questions, commentary, lectures, etc., and may collect the users' result data of access to the content database.

For example, the data analysis server may collect question solving result data, commentary inquiry data, or lecture video running data for all users. More specifically, the data analysis server may establish a database for various questions on the market, provide the question database to a user device, and collect solving result data in a way that collects solving results of a corresponding user for corresponding questions through the user device.

Furthermore, the data analysis server may organize the collected question solving result data into a list of users, questions, and results. For example, Y (u, i) refers to a result of question i solved by user u, and may have a value of 1 in the case of a correct answer and a value of 0 in the case of an incorrect answer.

However, a multiple-choice question consists of choice items as well as a text, and in the case where analysis is only based on whether a selected answer is correct or incorrect, if two students select different incorrect answers for the same question, the question may have the same influence in calculating vectors of the two students and therefore the influence of the question on analysis results may be diluted.

For example, in the case where a student selects an incorrect choice item regarding a gerund for a particular question and in the case where the student selects an incorrect choice item regarding a verb tense, according to the conventional method, the student's solving result may not be sufficiently reflected in calculating a vector value of the corresponding question and may be rather diluted.

Therefore, the data analysis server according to another embodiment of the present disclosure may extend the collected question solving result data by applying a choice item parameter selected by the user.

In this case, the data analysis server may configure the collected solving result data in the form of a list of users, questions, and choice items. For example, Y (u, i, j) refers to a result of question i solved by user u by selecting choice item j, and may have a value of 1 in the case of a correct answer and a value of 0 in the case of an incorrect answer.

In step 220, the data analysis server according to the embodiment of the present disclosure may construct a multidimensional space composed of users and questions, and may assign values to the multidimensional space based on whether the answer of each user for a corresponding question is correct or incorrect, thereby calculating a vector for each user and the question.

As another example, the data analysis server according to an embodiment of the present disclosure may construct a multidimensional space composed of user and choice items for each question, and may assign values to the multidimensional space based on whether each user selects the corresponding choice items, thereby calculating a vector for each user and each choice item.

If a user and a question are represented by a modeling vector according to an embodiment of the present disclosure, it is possible to mathematically calculate whether the answer of a particular user for a particular question will be correct, that is, a probability of correct answer of the particular user for the particular question.

For example, the data analysis server may estimate a level of understanding of the particular user for the particular question using the user modeling vector and the question modeling vector, and may estimate a probability that the answer of the particular user for the particular question will be correct using the estimated level of understanding.

For example, if values of a first row of a user modeling vector are [0, 0, 1, 0.5, 1], it can be interpreted that a first user does not understand the first and second concepts at all, completely understands the third and fifth concepts, and partially understands the fourth concept.

Further, if values of a first row of a question vector are [0, 0.2, 0.5, 0.3, 0], it can be interpreted that the first question does not include a first concept at all, includes a second concept by about 20%, includes a third concept by about 50%, and includes a fourth concept by about 30%.

On the other hand, in the data analysis system according to an embodiment of the present disclosure, if the user's level of understanding of a concept L and a level of concept inclusion of the question R are estimated with sufficient reliability, correlation between the user and the question can be mathematically connected through a low rank matrix.

For example, in the case where the total number of users to be analyzed is n and the total number of questions to be analyzed is m, if the number of unknown concepts constituting a corresponding subject is assumed as r, the service server may define a matrix L representing the user's level of understanding of each concept as n by r matrix and may define a matrix R representing a level of inclusion of each concept by a question as m by r matrix. In this case, if L is connected to a transposed matrix R^{T} of R, it is possible to analyze correlation between a user and a question without additionally defining concepts or the number of the concepts. That is, the matrix X for each user may be expressed as a multiple of L and the transposed matrix of R (X=LR^{T}).

If they are applied, in the above example where values of a first row of L are [0, 0, 1, 0.5, 1] and values of a first row of R are [0, 0.2, 0.5, 0.3, 0], a level of understanding X(1,1) of user 1 for question 1 may be calculated as X(1,1)=0.5-0.5×0.3=0.65. That is, user 1 may be estimated to understand question 1 by 65%.

However, the level of understanding of a user for a particular question and the probability that the answer of the user for the particular question will be correct cannot be said to be the same. In the above example, assuming that the first user understands the first question by 65%, when the first user actually solves the first question, what would be the probability that the answer of the first user for the first question will be correct?

To this end, the methodology used in psychology, cognitive science, pedagogy, and the like may be introduced to estimate a relationship between the level of understanding and the probability of correct answer. For example, the level of understanding and the probability of correct answer can be estimated in consideration of multidimensional two-parameter logistic (M2PL) latent trait model devised by Reckase and McKinley, or the like.

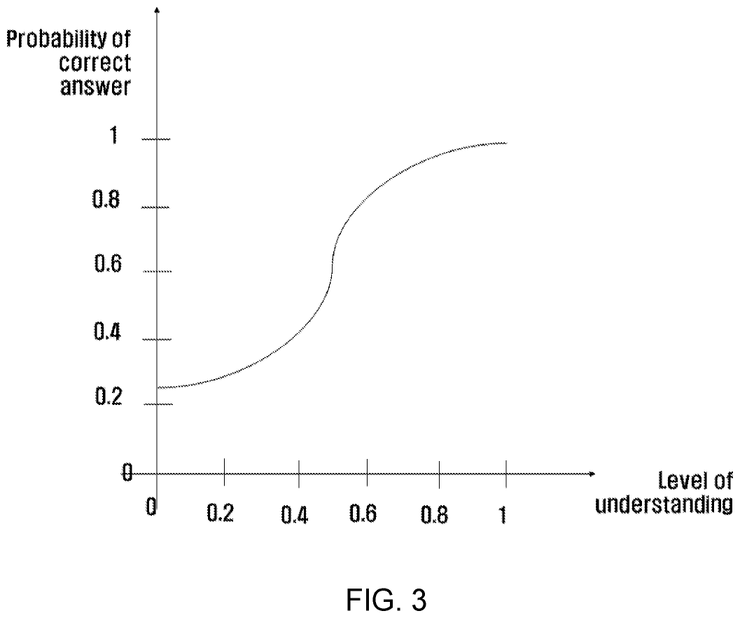

According to a result of experiment with sufficiently large data by applying the above theory, the level X of understanding of a question and the probability P that the answer of a user for the question will be correct are not linear, and a result in the form shown in FIG. 3 is observed.

FIG. 3 is a two-dimensional graph of results of experiments of the level X of understanding of the question and the probability P that the answer of a user for the question will be correct using a sufficiently large data, where X axis represents a level of understanding and Y axis represents a correct answer probability.

Through the graph, a function Φ for estimating a probability P that the answer of a user for a question will be correct may be derived as shown in the following equation. In other words, the correct answer probability P may be calculated by applying the question understanding level X to the function Φ.

Φ(x)=0.25+0.75/(1+e^{-10(x-0.5)})

In the above example in which the level of understanding of user 1 for question 1 is 65%, the probability that the answer of user 1 for question 1 will be correct may be calculated as P(1,1)=Φ(x(1,1))=0.8632, corresponding to 86%. That is, user 1 does not understand concepts 2 and 4 at all and completely understands concept 3 and that question 1 is composed of concept 2 by 20%, concept 3 by 50%, and concept 4 by 30%, it may be estimated that the probability that user 1 can correctly answer question 1 may be 86% according to the above equation.

However, according to the present disclosure, it is sufficient to calculate a correct answer probability of a user for a particular question by applying the conventional technique capable of estimating the relationship between the level of understanding and the probability of correct answer, in a reasonable way, and it should be noted that the present disclosure cannot be construed as being limited to a methodology for estimating the relationship between the level of understanding and the correct answer probability.

When a user modeling vector and a question modeling vector are calculated according to the above-described embodiment, the user modeling vector may be provided to mean a correct answer probability for a particular question using a correlation between the user modeling vector and the question modeling vector.

On the other hand, according to another embodiment of the present disclosure, a correct answer probability for a user for a question may be estimated using a probability of selection of each choice item for the question. For example, when a choice item selection probability of a first user for a particular question is (0.1, 0.2, 0, 0.7), the user may select choice item 4 with a high probability, and when the correct answer of the corresponding question corresponds to the choice item 4, it may be expected that the first user has a high probability of solving the question correctly.

To this end, the data analysis server may configure a multi-dimensional space with a user and a question-choice item as variables, assign values to the multi-dimensional space based on whether the user selects the corresponding question-choice item, and calculate a vector for each user and the question-choice item.

In this case, the selection probability may be estimated by applying various algorithms to the user modeling vector and the question-choice item modeling vector, and an algorithm for calculating a selection probability is not limited in interpreting the present disclosure. That is, using a correlation between the user modeling vector and the question-choice item modeling vector, the user modeling vector may be provided to mean a probability to select a particular choice item for a particular question.

For example, according to an embodiment of the present disclosure, if a sigmoid function such as the following equation is applied, it is possible to estimate a user's question-choice item selection probability (x is a question-choice item vector, θ is a user vector):

hθ(x)=1/(1+e^{(-θ*T*X)})

Furthermore, the data analysis server according to an embodiment of the present disclosure may estimate a correct answer probability for a question based on the user's choice item selection probability.

However, for example, when the choice item selection probability of a particular user for a particular question having four choice items is (0.5, 0.1, 0.3, 0.6) and the choice item corresponding to the correct answer is choice item 1, the probability that the user correctly answers the question becomes a problem. That is, a method for estimating the correct answer probability for the corresponding question using a plurality of choice item selection probabilities for the corresponding question may be considered.

As a simple method of converting a choice item selection probability to a correct answer probability according to an embodiment of the present disclosure, there is a method of comparing all choice item selection probabilities and a correct answer selection probability. In this case, in the above example, the correct answer probability of the corresponding user for the corresponding question may be calculated as 0.5/(0.5+0.1+0.3+0.6). However, when solving the question, the user does not divide the corresponding question in the unit of choice items to understand the question, but understands the question in the unit of questions including the configuration of all choice items and the intention of a person who makes questions, so that a choice item selection probability and a correct answer probability cannot be simply connected.

Accordingly, it is possible to estimate the correct answer probability of the corresponding question from the choice item selection probabilities through a method of averaging all choice item selection probabilities of the corresponding question and applying an averaged correct answer selection probability to all the choice item selection probabilities according to an embodiment of the present disclosure.

In the above example, when the choice item selection probability corresponds to (0.5, 0.1, 0.3, 0.6), the scale of the choice item selection probability may be changed to (0.33, 0.07, 0.20, 0.40) by averaging the choice item selection probability with respect to all choice items. When the correct answer is choice item 1, the averaged selection probability of choice item 1 is 0.33 and the averaged selection probabilities of all the choice items are (0.5+0.1+0.3+0.6), and thus, the correct answer probability of the corresponding user for the corresponding question may be estimated as 0.33/(0.5+0.1+0.3+0.6)=22%.

Further, the service server according to an embodiment of the present disclosure may estimate a correct answer probability of the question based on the question-choice item selection probability of the user, and may estimate a level of understanding by the user of a particular concept therethrough.

Meanwhile, in step 260, the data analysis model according to an embodiment of the present disclosure may generate an expert model T that coaches data necessary for efficiently updating the user and a question analysis model M. For example, the expert model T may be generated through reinforcement learning that is performed by taking actions based on state information of the analysis model M, update information of the analysis model M, and data information that causes the update, receiving rewards for the actions according to a change in the analysis model M, and performing learning in a direction to maximize a sum of the overall rewards.

For example, the data analysis server may assign an initial value Tᵢₙₜ of the expert model T in an arbitrary form, and may extract at least one arbitrary vector value to be recommended to the analysis model M. (Step 265). The vector may mean a question for collecting data necessary for improving performance of a user vector calculated by the analysis model M, that is, a reliability of a probability calculated by the analysis model M that an arbitrary user can correctly answer an arbitrary question.

Then, the vector value extracted from an expert model Tᵢₙₜ may be recommended to the analysis model M (step 267). Then, the analysis model M may identify at least one question having a modeling vector close to the vector value (step 225) and may provide corresponding questions to the user (step 230) to collect question solving result data and perform update based on the collected question solving result data (step 240).

Meanwhile, the state information of the analysis model updated according to the recommendation from the expert model Tᵢₙₜ may be used for learning of the expert model Tᵢₙₜ. More specifically, the expert model T may compare and learn prediction performance of the analysis model M, which has not been updated, and the analysis model M′, which has been updated, and may be evaluated and rewarded for its recommendation based on a value indicative of a change in the prediction performance of the analysis model (Step 270). Then, the expert model T may be updated in a direction to maximize the reward (step 275).

In step 270 of FIG. 2A, a reward according to an embodiment of the present disclosure may be interpreted to mean a direction or orientation of learning of the analysis model M. The reward may be set to update the analysis model M in a direction in which a correct answer probability or a choice item selection probability of a particular user for a particular question, which is predicted according to the analysis model M, coincides with the particular user's actual solving result, thereby improving the accuracy of the prediction of the analysis model M.

For example, a modeling vector U_{A} of user A, which is generated by applying the user A's data on results of solving questions 1, 2, 3, 4, and 5, may be considered. In this case, if U_{A} is a vector representing a probability of correct answer of the user A for all of the questions, it may be preferable that the data analysis model M is updated to improve prediction accuracy of U_{A}, that is, in a direction to reduce a difference between an actual result of the user A solving each question and a probability of correct answer of the user A for each question estimated by the data analysis model M, and the expert model T should be updated to recommend data necessary for the data analysis model M to be updated in the aforementioned direction.

For example, the expert model T may recommend a vector for a question requiring solving result data in order to improve the prediction accuracy of the U_{A} at a corresponding point in time. In this case, the data analysis server may extract question 6 having a modeling vector close to the recommended vector value, may provide the user A with question 6, and may collect solving result data of the user A for question 6. The solving result data may include information on a choice item selected by the user A for question 6, the correct choice item for question 6, and a point in time of solving question 6, and the data analysis model M may be updated by applying the solving result data. When the user A's modeling vector U_{A} is changed by ΔU_{A} and thereby updated to U_{A}′, the expert model T may receive information on ΔU_{A}, U_{A}′, and a modeling vector Q₆ of question 6 from the data analysis model M.

In this case, the expert model T may generate a reward by determining whether it is appropriate to recommend question 6 based on ΔU_{A} representing information on a direction to update the data analysis model M and U_{A}′ representing state information of the data analysis model M at the corresponding point in time, that is, by determining whether performance of the data analysis model M updated by applying the data on the result of solving question 6 is improved, and then the expert model T may be updated by applying the reward.

For example, if it is not appropriate to recommend question 6, the expert model T may be learned to extract a vector different from Q₆ when the analysis model M is in the state of U_{A}.

For example, when a difference between a correct answer probability, which is estimated based on a user modeling vector U_{A} generated based on data on the user A's results of solving questions 1, 2, 3, 4, and 5 and the vector Q₆ of question 6, and actual solving result of the user for question 6 is smaller than a difference between a correct answer probability, which is estimated based on a user modeling vector U_{A}′ generated based on solving result data of the user A for questions 1, 2, 3, 4, 5 and 6 and the vector Q₆ of question 6, and an actual solving result of the user A for question 6, it may be interpreted that prediction accuracy of the analysis model M is reduced as a result of applying the solving result data for the question 6. In this case, the expert model T may be updated by applying a negative reward to (ΔU_{A}, U_{A}′, Q₆). In this case, the expert model T may be learned in a direction to recommend a question not similar to question 6 in a state of a similar data analysis model M, that is, to extract a vector not similar to Q₆.

On the other hand, if it is appropriate to recommend question 6, the expert model T may be learned to extract a vector similar to Q₆ when the analysis model M is in the state of U_{A}.

For example, when a difference between a correct answer probability, which is estimated based on the user modeling vector U_{A} and the vector Q₆ of question 6, and actual solving result of the user A for question 6 is larger than a difference between a correct answer probability, which is estimated based on U_{A}′ and Q₆, and actual solving result of the user A for question 6, it may be interpreted that prediction accuracy of the analysis model M is improved as a result of applying the solving result data for question 6. In this case, the expert model T may be updated by applying a positive reward to (ΔU_{A}, U_{A}′, Q₆). In this case, the expert model T will be learned to extract a vector similar to Q₆ in the direction to recommend a question similar to the question 6 in the state of the similar data analysis model M.

As described above, while a reward applied to the expert model T can be set in a direction to improve prediction accuracy of the data analysis model M, according to another embodiment of the present disclosure, the reward may also be set in a direction to narrow a prediction score variance range. In this case, the expert model T may be formed in a direction of extracting data to be learned so that prediction of the analysis model M can be more accurate.

Then, in step 275, the expert model T may be updated by learning data (ΔU_{A}, U_{A}′, Q), received from the analysis model M, according to the reward.

Meanwhile, if the scope of learning of the analysis model M and/or the expert model T increases, the performance of the model may increase but the amount of resources required to operate a data analysis framework may increase. Therefore, it is necessary to consider an optimal scope of learning.

Step 280 is a step for learning the analysis model M and/or the expert model T to an optimized level. When the performance of the analysis model M formed at a corresponding point in time is not sufficient, the expert model T may continue recommending data for learning the analysis model M, but when the performance of the analysis model M is sufficient, the expert model T may end recommending data, and the data analysis server may analyze a user and/or content using the analysis model M formed at the corresponding point in time.

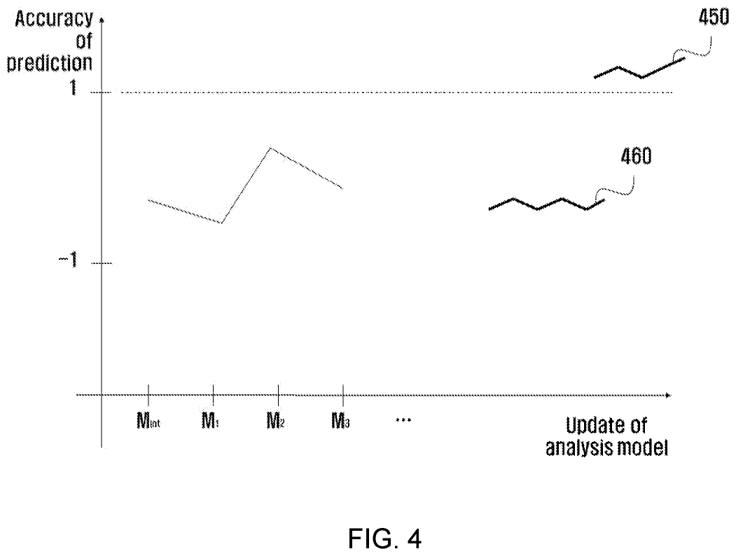

For a situation in which the expert model T ends recommending data, that is, a situation in which the analysis model M and/or the expert model T is sufficiently learned, three cases may be considered primarily. FIG. 4 is a view for explaining the case of ending update of the analysis model M and/or the expert model T.

The first case is the case where a user and/or question can be analyzed sufficiently with the analysis model M formed at the corresponding point in time. For example, this case refers to the case where even if the analysis model M is not additionally learned based on the user A's question solving result data, the analysis model M can estimate a correct answer probability of the user A for all questions with a sufficient accuracy using a user vector U_{A} or the analysis model M can estimate the user A's external test score with a sufficient accuracy. In this case, this may be determined by determining whether accuracy of an estimated value calculated by the analysis model formed at the corresponding point in time is equal to or greater than a threshold (step 450 in FIG. 4).

The second case is the case where even if question solving result data is additionally learned, the characteristics of the user or question cannot be identified any longer. That is, this is the case where there is no effect of learning, that is, the case where no change in the analysis model M is expected even if data is additionally learned according to recommendation from the expert model T. For example, this may be the case where despite addition of question solving result data of user A, accuracy of an estimated value calculated based on the user vector U_{A} is not changed and remains within an arbitrary range (step 460 in FIG. 4).

The third case is the case where data recommended by expert model T is already reflected in the analysis model M. For example, this may be the case where when the user vector U_{A} is generated using the user A's solving result data for the first to twentieth questions, a recommended question calculated by the expert model T is one of the first to twentieth questions.

If an end condition is satisfied, the expert model T may end recommending data, and accordingly, learning of the expert model T and the analysis model M may also be ended. On the other hand, if the end condition is not satisfied, the expert model T may extract data necessary for learning of the analysis model M at the corresponding point in time and may recommend the data to the analysis model M.

In particular, according to an embodiment of the present disclosure, state information of the analysis model M acquired by the expert model T in step 245, update information of the analysis model M, and question modeling vector information that causes update of the analysis model M may be used for learning of the expert model T (step 275) and may be used as an input to the updated expert model to determine next data to recommend (step 285).

That is, with reference to state information of the analysis model that has changed according to the previous recommendation, the expert model T may recommend next data necessary for improving performance of the analysis model M.

In the above example for the user A, if the modeling vector U_{A} for the user A is updated into U_{A}′ as the solving result data for the sixth question is applied according to recommendation from the expert model T, the expert model T may calculate, based on information on ΔU_{A}, U_{A}′, and the modeling vector Q₆ for the sixth question, a next vector value to recommend in order to improve the performance of U_{A}′. The vector may refer to a question for collecting data necessary for improving performance of the user vector U_{A} calculated by the analysis model M, that is, a reliability of a probability that the user A correctly answers an arbitrary question, calculated according to the analysis model M.

Then, the analysis model M may extract a question vector having a similarity within a preset range with a vector received from the expert model T, may provide the extracted question vector to the user, and may learn solving result data for a corresponding question.

Meanwhile, if the expert model T is operated according to an embodiment of the present disclosure, it is possible to efficiently configure a set of optimized diagnostic questions necessary for analysis of a new user.

In the case of a new user or question, analysis results cannot be provided until data for the user or question is accumulated. Therefore, it is necessary to efficiently collect learning result data for a new user or question required for deriving initial data, that is, initial analysis results, with certain reliability from a data analysis framework. In general, diagnostic questions may be provided to a new user, and an initial analysis model of the new user may be generated using question solving results for the diagnostic questions.

In this case, more precise analysis is possible along with an increase in the number of diagnostic questions. However, the user may wish to receive a sufficiently reliable analysis result even by solving less diagnostic questions. Therefore, it is necessary to establish of diagnostic questions with minimal questions that can secure the reliability of user analysis results in a certain range or more. However, if the expert model T according to the embodiment of the present disclosure is operated, it is possible to provide a reliable analysis result without a user having to solve many questions.

When a new user is introduced, the data analysis server according to an embodiment of the present disclosure may randomly extract at least one question from a question database, may provide the extracted question to the new user, may set a user modeling vector Uᵢₙₜ for the new user by applying question solving result data, and may notify the expert model T of the user modeling vector unit.

For example, if a first question composed of choice items a, b, and c is provided to a particular new user and the new user selects the answer a for the first question, the data analysis server may calculate an initial modeling vector of the new user u_{new} by applying data (u_{new}, 1, a)=1, (u_{new}, 1, b)=0, (u_{new}, 1, c)=0 to the data analysis framework.

Then, the expert model T according to an embodiment of the present disclosure may recommend at least one question vector necessary for diagnosing the new user.

In this case, the data analysis server may provide the new user with diagnostic questions according to recommendation from the expert model T. The analysis model M may update a user vector by applying solving result data of the user for the diagnostic questions, and may notify the expert model T of information on the updated user vector, a changed value of the user vector, and a diagnostic question vector.

If performance of a user model U is improved, the expert model T may learn information by applying a positive reward, and if the performance of the user model U is degraded, the expert model T may learn information by applying a negative reward. Then, the expert model T may determine whether the performance of the user model U is sufficient and may recommend a question vector necessary to improve the performance of the user model U until the performance of the user model U reaches or exceeds a preset level.

Meanwhile, the example of FIG. 2A described above relates to the case where the analysis model M and the expert model T are updated by reflecting the data collection result while the analysis model M provides a user with recommended questions. Meanwhile, according to another embodiment of the present disclosure, a framework for operating an analysis model to recommend questions to a user and a framework for learning an expert model may be implemented in logically and/or physically separated computing devices. More specifically, a system for recommending questions to a user and a system for learning of an expert model may be operated while separated logically and physically.

FIG. 2B is a flowchart illustrating the above embodiment of the present disclosure. In the description of FIG. 2B, description of the parts repeated from FIG. 2A will be omitted.

In step 270 of FIG. 2B, the framework for operating the expert model T may record a history of update information of the analysis model. That is, the history on state information of the analysis model M, information of the update M′, and question modeling vector that causes the update may be recorded. Furthermore, unlike FIG. 2A, the expert model T may not be updated, and instead, unless the end condition is satisfied (step 280), a question vector may be suggested to the analysis model M using the expert model T (step 265).

Meanwhile, the framework for operating the expert model T may be updated at an arbitrary point in time by reflecting update history information of the analysis model (step 275). At this time, a reward for setting an update direction of the expert model T may be applied (step 270), and this may be substantially the same as the embodiment of FIG. 2A.

The embodiments of the present disclosure disclosed in the present specification and drawings are intended to be illustrative only and not for limiting the scope of the present disclosure. It will be apparent to those skilled in the art that other modifications based on the technical idea of the present disclosure are possible in addition to the embodiments disclosed herein.

1. A method for analyzing a user in a data analysis server, the method comprising:
step A of establishing a question database comprising a plurality of questions, of collecting solving result data of a user for the plurality of questions, and of learning the solving result data, thereby generating a data analysis model for modeling the user;
step B of generating an expert model that operates independently of the data analysis model, that is learned based on data different from data for the data analysis model, and that recommends learning data necessary for the data analysis model to improve performance of the data analysis model at an arbitrary point in time;
step C of extracting at least one question from the question database according to recommendation from the expert model, and of updating the data analysis model using solving result data of a user for the at least one extracted question; and
step D of updating the expert model by applying, to update information of the data analysis model, a reward that is set in a direction to improve prediction accuracy of the data analysis model,
wherein the step B comprises generating the expert model by learning information on a first state of the data analysis model, information on a second state of the data analysis model, and data information causing the first state to change into the second state.

2. The method of claim 1,
wherein the step A comprises calculating a user modeling vector representing characteristics of each user for the question, and estimating a correct answer probability of each user for the question using the user modeling vector, and
wherein the step D comprises updating the expert model by applying a reward that is set to improve prediction performance of the user modeling vector, the prediction performance corresponding to a difference between actual solving result of a user for the question and a correct answer probability estimated for the question using the user modeling vector.

3. The method of claim 1,
wherein the step A comprises calculating a user modeling vector representing characteristics of each user for the question, and estimating a predicted score of a user for an external test using the user modeling vector without using the question database, and
wherein the step D comprises updating the expert model by applying, to the update information of the data analysis model, a reward that is set to reduce a standard deviation of the predicted score.

4. The method of claim 2, wherein the step C comprises, when a rate of change of the prediction performance of the user modeling vector is within a preset value, determining that there is no effect of additional learning of the data analysis model, and ending the recommendation from the expert model.

5. The method of claim 2, wherein the step C comprises, when the prediction performance of the user modeling vector is out of a preset range, determining that the data analysis model is sufficient for analysis of the user without performing additional learning, and ending the recommendation from the expert model.

6. The method of claim 2, wherein the step C comprises, when solving result data for a question recommended by the expert model is already reflected in the user modeling vector, ending the recommendation from the expert model.
